(19) United States
(12) Patent Application Publication
(10) Pub. No.: US 2009/0129953 A1
(43) Pub. Date: May 21, 2009

(54) PUMP, POWER PLANT, A WINDMILL, AND A METHOD OF PRODUCING ELECTRICAL POWER FROM WIND ENERGY

(75) Inventor: Henning Andersen, Middelfart (DK)

Correspondence Address: KLEIN, O'NEILL & SINGH, LLP, 43 CORPORATE PARK, SUITE 204, IRVINE, CA, 92606, US

(73) Assignee: Elsam A/S, Fredericia (DK)

(21) Appl. No.: 11/575,485

(22) PCT Filed: Sep. 19, 2005
(86) PCT No.: PCT/DK2005/000588

§ 371 Date: Aug. 12, 2008

(30) Foreign Application Priority Data
Sep. 17, 2004 (EP) EP 04388063.2

(51) Int. Cl. F04B 17/02; F03D 9/00; F03D 11/00

(52) U.S. Cl. 417/334; 60/398; 290/55

(57) ABSTRACT

Power plant (10) for the generation of electrical power using wind power or wind energy, comprising a plurality of windmills (12, 14, 16) each comprising a mill tower, a rotor (18, 20, 22) with a shaft (32) being rotatably journalled in said mill tower, a fluid pressure generator (34) mounted in said mill tower and being coupled to and driven by said shaft for delivering pressurised fluid to a pressure channel (36). A pressure accumulating reservoir (42) communicates with said pressure channels for receiving said pressurised fluid therefrom, and a pressure driven electrical power generator (48) connected to said pressure accumulating reservoir is driven by said pressurised fluid for generation of electrical power. Also disclosed are a windmill for use in such a powerplant and a method of producing electrical power from wind energy.

In the modern world, the consumption of electrical power by consumer electronics and electrically driven devices in the industry is rising every year. Also, the public demand for using environmentally friendly sources of power, i.e. power plants that are not coal, oil, diesel or nuclear based, is also increasing. Examples of such power sources or power plants are windmills, water mills, solar energy plants, etc.

The use of mills or turbines has been known for centuries, e.g. windmills, wind turbines, water mills and water turbines have been used for grinding grain into flour. The basic design included a rotor driven by the wind or the water. The rotor was connected to a shaft, again connected to one or more shafts driving a grinder.

Related art may be found publications such as U.S. Pat. No. 4,496,846, U.S. Pat. No. 4,206,608, GB 2 370 614 and FR 2 814 504. Reference is made to all of the mentioned patent publications, and all are hereby incorporated in the present specification by reference.

One problem associated with producing electrical power from wind using a pump generating a pressurised fluid is variations in the wind speed, which in turn may cause variations in the pressure of the fluid. The change in pressure in fluid may also cause change in the electrical power generated using that fluid.

In accordance with a first aspect of the present invention, a pressure generating pump is provided. The pressure generating pump may comprise:
i) a pressure pump housing in which a pressure chamber is defined, the chamber having a fluid inlet and a fluid outlet for receiving and supplying a non-pressurised and a pressurised pressure fluid, respectively,
ii) a piston rod having a piston head received within the pressure chamber for reciprocal creating movement within the chamber,
iii) a rotatably journalled power transmitting axle for receiving rotational motion from a rotational motion generator such as a windmill rotor or wind turbine or water mill or water turbine,
iv) a crankshaft assembly connected to the axle for transformation of the rotational motion into a pendulum motion,
v) a power regulating and transmitting lever arm assembly defining a first and a second end, the first end being connected to the crankshaft assembly and the second end being connected to the piston rod for transforming the pendulum motion into the reciprocating movement, and
vi) the lever arm assembly being journalled on a repositionable pivot repositionable between the first and second ends and defining a first arm between the first end and the pivot and defining a second arm between the pivot and the second end, the length of the first arm being lengthened or shortened by repositioning the pivot and at the same time the second arm being shortened or lengthened, respectively, by the repositioning of the pivot.

The pressure generating pump is contemplated to transform the rotation of e.g. a windmill axle to reciprocating motion of a piston rod in a pressure chamber. The transformation from rotational energy or motion to pendulum motion of the power regulating and transmitting lever arm assembly enables the control of power and motion transmitted to the piston rod for transforming the pendulum motion into the reciprocating movement. The control is achieved by the repositionable pivot repositionable between the first and second ends of the lever arm. Changing the centre of rotation or pivot of the lever arm controls or changes the pressure generated in the pressure chambers. The pressure generating pump relies on the principle of the lever, as the lengths of the arms of the lever is changed in accordance with the changing of the centre of rotation or pivot.

Further more, the pressure-generating pump may include a plurality of pressure chambers, such as 2, 3, 4, 5 or 6 pressure chambers. More that one chamber may be necessary in order to provide a substantially even flow or pressure from the pressure generating pump. The chambers may be positioned oppositely, side-by-side or with angular offset or spacing.

In one embodiment, the pressure chambers may be provided in pairs operating in a push-pull configuration. The pressure chambers may e.g. be provided at opposite ends of a reciprocating piston rod. Other constructions may be contemplated.

In accordance with the basic teachings of the present invention, the repositionable pivot may be fixated to a base at one end. The base may e.g. be the housing of the narcell of a windmill.

Specifically, the ratio between the length of the first arm and the length of the second arm may be variable in the interval 1:1 to 1:1000, such as 1:1,5 to 1:100, such as 1:2 to 1:50, such as 1:2,5 to 1:25, such as 1:3 to 1:15, such as 1:3,5 to 1:10, such as 1:4 to 1:8, such as 1:4,5 to 1:7, such as 1:5 to 1:6,5, such as 1:1 to 1:3, such as 1:3 to 1:4, such as 1:4 to 1:5, such as 1:5 to 1:6, such as 1:7 to 1:8, such as 1:8 to 1:9, such as 1:9 to 1:10, such as 1:10 to 1:12, such as 1:12 to 1:15, such as 1:15 to 1:20, such as 1:20 to 1:50, such as 1:50 to 1:100, such as 1:100 to 1:1000. The ration between the lengths of the arms controls or changes the amount of force applied from the lever arm to the piston rod, and thereby to the piston heads in the one or more pressure chambers. The ration may be defined and understood as either the first arm length divided by the second arm length and by the second arm length divided by the first arm length.

In an embodiment of the pressure generating pump in accordance with the first aspect, at least one of the pressure chambers may define a first and a second pressure chamber on the distal and proximal side of a piston head, and the pressure chamber may include a sealing member. The sealing member seals the pressure chamber at the point where the piston enters the pressure chamber. Pressurised fluid is generated in the chamber when the piston is moved in both directions, e.g. up and down or in and out of the chamber.

One problem with these old-fashion, and also the more modern implementations of windmills for generating electrical power, is that they are dependant on weather factors, i.e. the wind or precipitation. If the wind is too hard, the windmill needs to be slowed down by, e.g., a break. Also, the wind seldom effects the windmill at a constant power or speed, so a need for evening out the fluctuations also exists.

The basic teachings of a second aspect of the present invention provides a power plant for the generation of electrical power using wind power wind energy, that comprises:
a plurality of windmills each comprising a mill tower, a rotor with a shaft being rotatably journalled in the mill tower, a fluid pressure generator mounted in the mill tower and being coupled to and driven by the shaft for delivering pressurised fluid via a pressure channel, a pressure reservoir positioned within the mill tower and being in fluid communication with the fluid pressure generator and the pressure channel,
a pressure accumulating reservoir communicating with the pressure channels for receiving the pressurised fluid therefrom, and
a pressure driven electrical power generator connected to the pressure accumulating reservoir and being driven by the pressurised fluid for generation of electrical power, the electrical power delivered to an electrical power supply grid.

The windmill comprises a rotor being driven by the wind in the area. The rotational energy delivered to the rotor from the wind is transported or transferred to a main shaft in the windmill. The main shaft preferably rotates at a low rotational speed. A gear may be inserted between the main shaft and a fast rotating electrical power generator delivering electrical energy or power to an electrical power supply grind.

The pressure reservoir within the mill tower is contemplated to even out the fluctuations that is bound to be in the generated pressure from the pressure generator, as the pressure generator is dependent on the wind speed or wind pressure. Fluctuations in the pressure generated may lead to fluctuations in the electrical power generate therefrom, which is not desirable. The pressure reservoir within the mill tower is also contemplated to act as a buffer in case of severe storms or wind conditions. The size of the pressure reservoir within the mill tower may be determined by the size of the wind mill tower and the expected worst case scenario for the location where the windmill is positioned.

The plurality of windmills may be replaced with a single windmill park e.g. for generation of electrical power at a specific location, such as a farm or small village.

The windmills may be placed on land or in the sea, preferably so they may take advantage of a position with sufficient wind to drive the rotor. Presently, windmills produce around 2000 kW of electrical power. Developing larger windmills lead to higher towers with rotors having large or long wings.

Long wings rotating at a high velocity usually produce noise levels that are unacceptable for neighbours, which lead to limitations in the speed or velocity at which the windmills are driven. The lower number of revolutions at increased rotor diameter implies a need for a greater gear ratio in a gear means.

The size of the gears needed for such a windmill along with increased deflection of the higher windmill tower adds loads to the bearings and gear wheel.

The production of electrical energy or power from a windmill may vary substantially within a short period of time, resulting in a considerable need for regulating the rotation of the rotor, e.g. by applying a break, or distributing a plurality of windmills over a large area as it is not possible to store energy generated from a windmill. The present invention provides a pressure accumulating reservoir to accommodate this need for storing energy generated by one or more windmills.

The fluid pressure generator mounted in the mill tower pressurises the fluid so that the fluid may be transported via a pipe, tube or similar, system to an electrical power generator. However, the pressure accumulating reservoir may receive the pressurised fluid and store this fluid, thereby enabling the storage of energy, e.g. in situation where there is generated more electrical energy than needed in the electrical power supply grid.

Storage of pressurised fluid is also contemplated to diminish the effect of fluctuations in the pressure generated by the fluid pressure generator, as caused by the fluctuations in the wind.

An embodiment where the pressure accumulating reservoir is divided into two or more chambers or constituted by two or more containers or tanks, it is contemplated to be possible to utilise the pressure accumulated in one tank while filling the remaining tanks, thereby also achieving an even supply of pressurised fluid to the electrical power generator.

A first advantage of the present invention relates to the pressurised fluid being constituted by a liquid, such as seawater or freshwater including friction reducing additive or a gas, such as an inert gas, such as nitrogen or atmospheric air.

Smaller plants having a short transmission length of the fluid may use ordinary water, either saltwater or freshwater, as working medium. Pressure losses in plants may be reduced significantly by adding a friction or drag reducing additive.

A second advantage relates to the power plant according to the present invention, wherein the pressurised fluid is in a closed system including a return pump for returning the pressurised fluid from the pressure driven electrical power generator or alternatively an open system wherein the pressurised fluid is delivered to the surroundings from the pressure driven electrical power generator.

In the open system windmills and/or watermills and/or wave mills may drive pumps that are fed with water from saltwater areas, freshwater areas or brackish water areas. The water may be filtered before it is lead into a pipe system. After the water has been used for producing electrical power in the electrical power generator, the water may be returned to the surroundings, preferably, and usually, without being contaminated in the process.

The water in a closed system may be treated so that it is less corrosive to the pipe system.

In both the closed and the open system, a means for lowering the freezing point of the water may be added.

A first feature of the present invention, relates to each of the shafts of the windmills being a horizontal or vertical shaft. Alternatively a combination thereof, possibly including a gear means or coupling in-between the vertical and the horizontal shafts.

A second feature of the present invention, relates to the fluid pressure generator being a slow-moving displacement pump, preferably a membrane-piston pump.

A third feature of the present invention, relates to the fluid pressure generator being coupled to the shaft via a gear means having a conical output stage, so that the output shaft co-insides with the shaft through the housing of the windmill, and being a multi-step centrifugal pump or screw pump or Archimedean screw.

A fourth feature of the present invention, relates to the fluid pressure generator may include a valve, the valve in a closed state functioning as a break for the windmill.

When the valve is in the closed state, the rotor will be slowed down by the increased pressure in the fluid. The use of fluid as break means for the windmill is contemplated to reduce the mechanical stress induced on the gear and/or shaft during the slowing down of the rotor.

It is a first object of the present invention to provide a pressure accumulating reservoir placed in or on a central platform including the pressure driven electrical power generator.

The pressure accumulating reservoir may be placed and, at or in a central platform or area where the pressure driven, electrical power generator is also placed nearby. The size of the pressure accumulating reservoir depends on the number of windmills, water mills or submerged water mills or a generator for generating power from waves in the sea.

A fifth feature of the present invention relates to the power plant further including a multitude of pressure reservoirs positioned at or in one or more windmills.

An embodiment with two or more pressure reservoirs enables a temporary storing of the generated pressurised fluid, which may be advantageous for periods of time, where excessive pressurised fluid is generated compared to the need for using the generated pressurised fluid for the production of electrical energy. Also, the pressure reservoir may act as a buffer, as the production of pressurised fluid depends on the amount of wind, which may vary greatly within a short period of time, thereby causing fluctuations in the generation of pressurised fluid. A buffer will enable a substantially constant release of pressurised fluid from a specific windmill into the system connected to the electrical power generator. By adding a monitoring system and/or controlling system for controlling the release of pressurised fluid from the individual pressure reservoir positioned at or in one or more of the windmills, the flow of pressurised fluid into the electrical power generator may be controlled so as to generate electrical power in synchronism with electrical power generated at other electrical power plants.

A sixth feature of the present invention relates to the pressure reservoir being constituted by at least two pressure reservoirs in a series or parallel connection.

An embodiment of the pressure reservoir as constituted by two or more pressure reservoirs as constituted by two or more pressure reservoirs connected in series or parallel connections enable a distribution of the pressurised fluid generated by the windmills, e.g. one pressure reservoir may be filled with pressurised fluid from one or more windmills at the same time, at which a second pressure reservoir delivers the pressurised fluid in a controlled manner to the electrical power generator. Using multiple pressure reservoirs are contemplated to facilitate control of the pressure and/or flow of the pressurised fluid into the electrical power generator.

According to a second object of the present invention each of the multitude of pressure reservoirs may be integral with the windmill and in the form of a hydrophore in the body of the mill tower or the foundation of the windmill. Each of the hydrophores may act as an energy buffer and/or energy storage.

A seventh feature of the present invention relates to the pressure driven electrical generator being controlled with regulated number of revolutions for sustaining synchronism with the electrical grid.

The electrical generator may be controlled or regulated from an external source for ensuring that the electrical power generated by the electrical generator is in synchronism with the electrical grid to which it is connected and to which it delivers the electrical power.

An eighth feature of the present invention relates to the pressure-accumulating reservoir being further connected to at least one fluid pressure generator being coupled to wave power plants or water turbine plants.

According to a third aspect of the present invention, a windmill for use in a power plant according to the second aspect of the present invention is provided. The windmill preferably includes a mill tower, a rotor with a shaft being rotatably journalled in the mill tower, a fluid pressure generator mounted in the mill tower and being coupled to and driven by the shaft for delivering pressurised fluid via a pressure channel.

The windmill according to the third aspect of the present invention may further include any of the features according to the second aspect of the present invention.

The present invention provides a method of producing electrical power from wind energy according to a fourth aspect. The method comprises the steps of:
i) providing at least one windmill including a mill tower, a rotor with a shaft being rotatably journalled in the mill tower, a fluid pressure generator mounted in the mill tower and being coupled to and driven by the shaft for delivering pressurised fluid via a pressure channel, the wind energy driving the rotor, a pressure reservoir positioned within the mill tower and being in fluid communication with the fluid pressure generator and the pressure channel,
ii) providing an electrical power generator communicating with the pressure channel,
iii) driving the electrical power generator with the pressurised fluid for the generation of electrical power,
iv) delivering the electrical power to an electrical power supply grid or an electrical power storage.

The pressure reservoir positioned within the mill tower may act as a buffer for the pressurised fluid generated from the fluid pressure generator during e.g. storms or other extreme weather conditions, or even during normal operation where the wind speed varies thereby varying the pressure generated by the fluid pressure generator.

The method according to the fourth aspect may further comprise intermediate steps after step ii), namely:
a) providing a storage device for storing the pressurised fluid under pressure, the storage device in communication with the pressure channels and the electrical power generator, and
b) delivering the pressurised fluid to the electrical power generator.

The temporary storing of the pressurised fluid enables a buffering of the generated pressurised fluid for evening out the fluctuations in the generated pressurised fluid. The term generated pressurised fluid is to be construed as a term covering the pressurisation of fluid, and not the generation of a fluid.

The method according to the fourth aspect may advantageously further comprise a step of providing a monitoring means for monitoring demand for electrical power on the electrical power supply grid,
performing the step b) when the monitoring means detect a specific need in the electrical power supply grid.

The monitoring means may be constituted by a computer or a plurality of computers connected in a network and include input and output means, such as screens, printers, mice, keyboards etc. The monitoring means may include automatic detection of the need for electrical power and may be connected to one or more generators for controlling the generation of electrical power.

Also the at least one windmill used in connection with the fourth aspect of the present invention may include any of the features of the windmill described in connection with the first and second aspect of the present invention, as well as the pump according to the first aspect of the present invention may include any of the features of the second, third and/or fourth aspect.

The present invention is to be described in greater detail with reference to the drawings, in which:

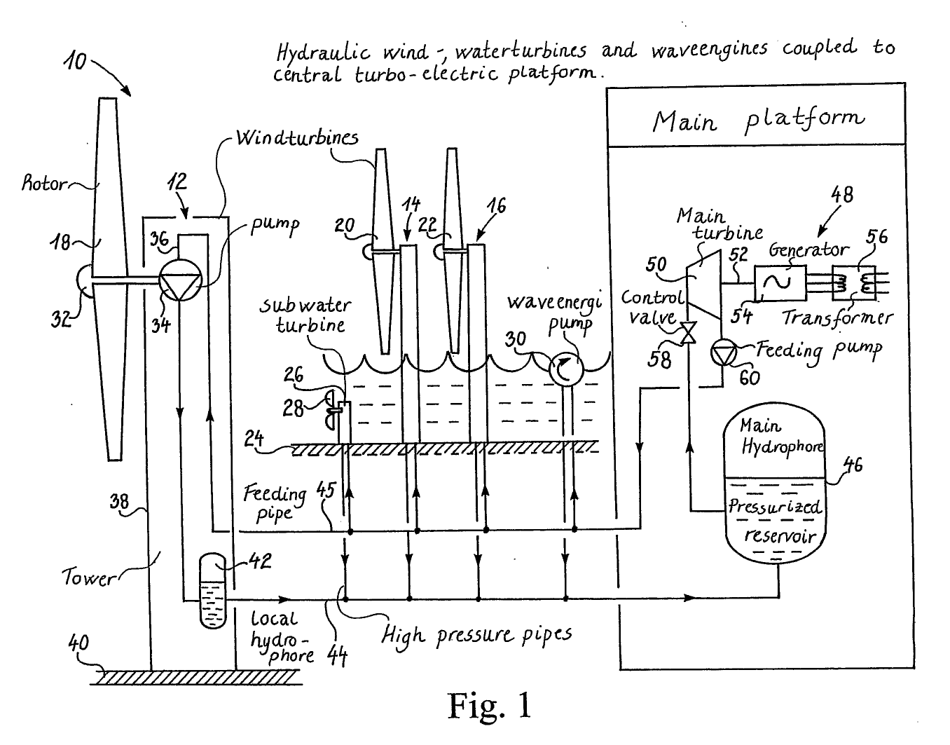

FIG. 1 is a schematic view of a power plant,

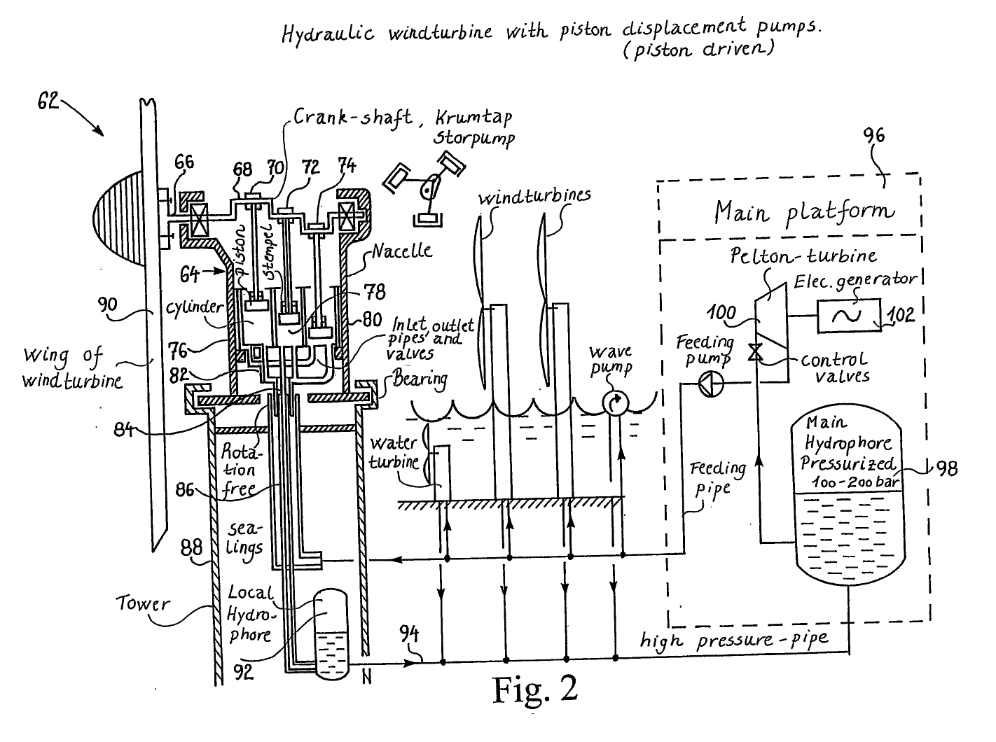

FIG. 2 is a schematic view of a hydraulic wind turbine,

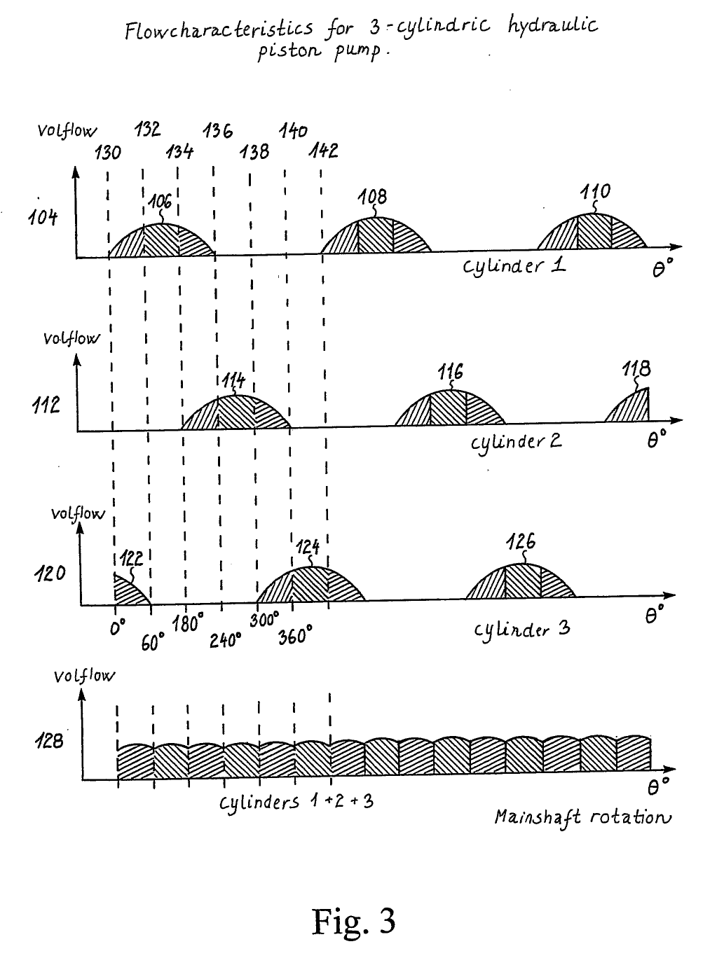

FIG. 3 is a schematic view of the flow characteristics for a 3-cylindric hydraulic piston pump,

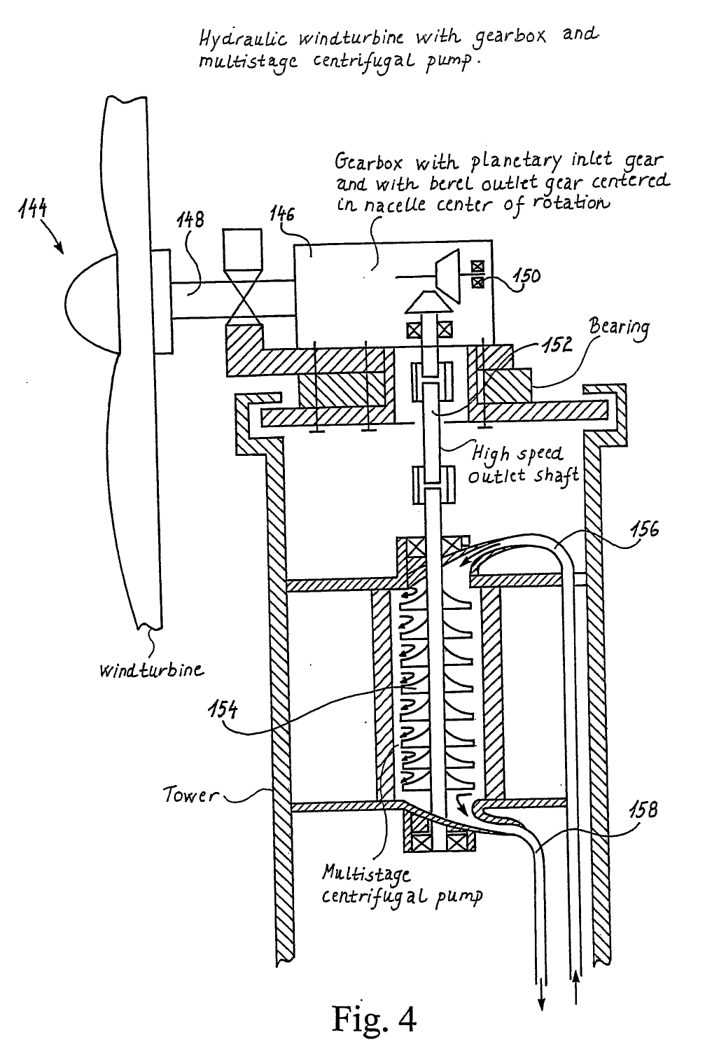

FIG. 4 is a schematic cut-through view of a windmill or wind turbine,

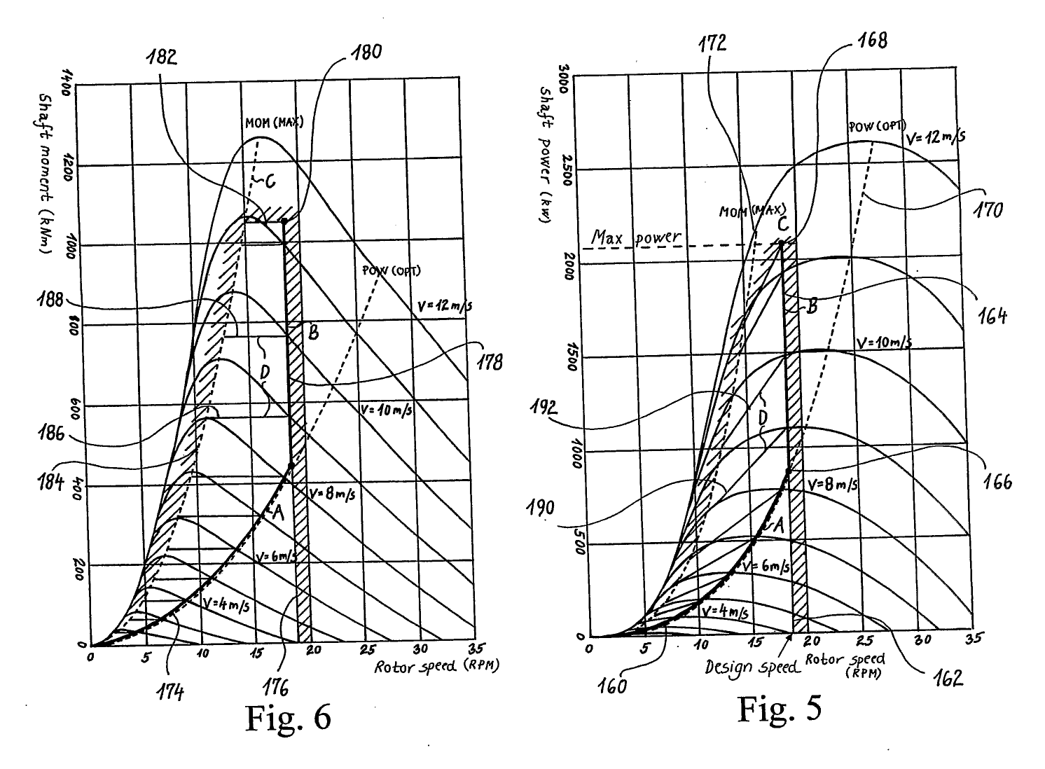

FIGS. 5 and 6 schematically illustrates power and shaft moments as a function of mean wind and rotor speed for a wind turbine,

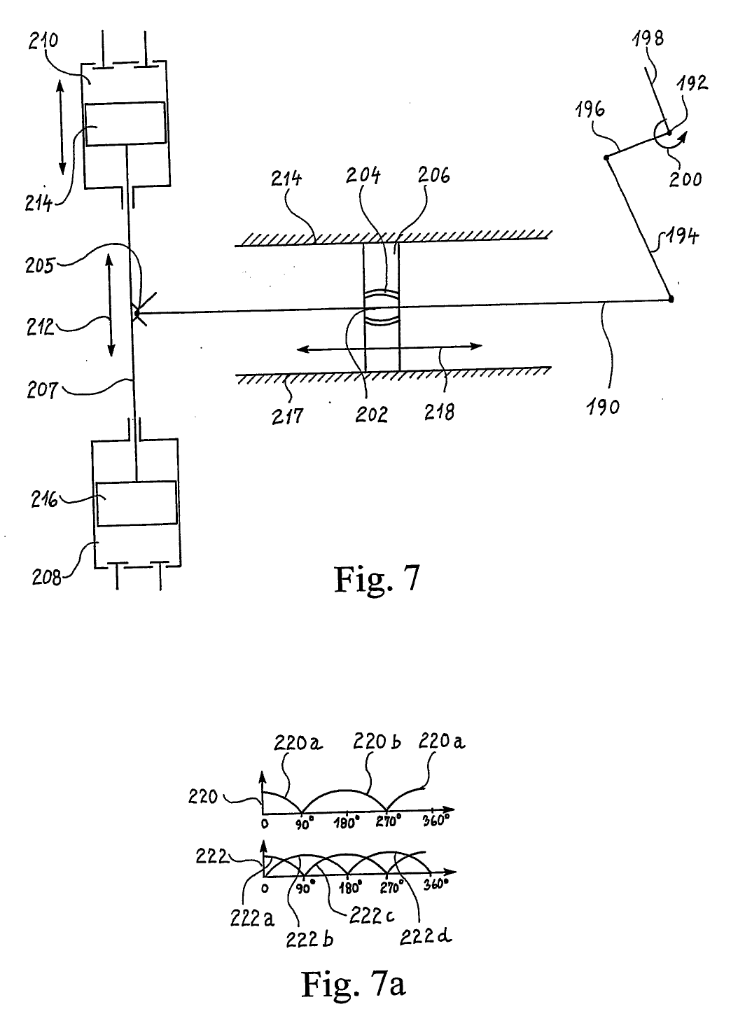

FIG. 7 schematically illustrates a pressure pump,

FIG. 7a schematically illustrates volume flow as a function of angle,

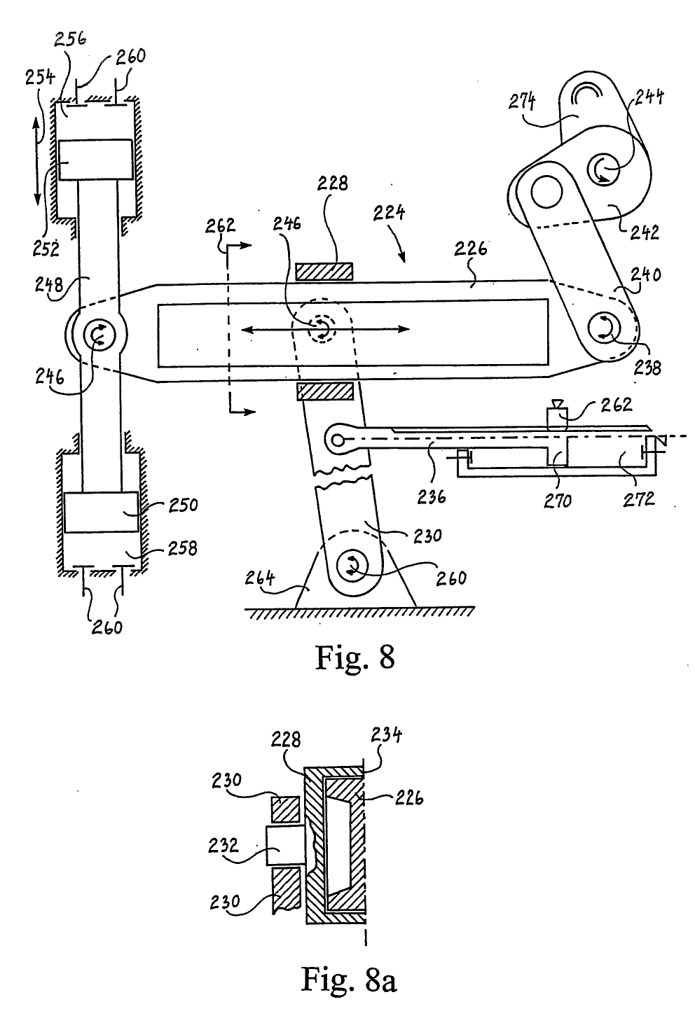

FIG. 8 schematically illustrates an embodiment of the piston pump of FIG. 7, and

FIG. 8a schematically illustrates a cut-through view of a part of the piston pump of FIG. 8.

FIG. 1 is a schematic view of a power plant generally assigned the reference numeral 10 comprising three windmills 12, 14, 16, each comprising a rotor 18, 20, 22. The windmills 14 and 16 are illustrated as being placed in water and fixated on the ocean bottom 24. At the ocean bottom 24, also a sub water turbine 26 has been placed. The sub water turbine also comprises a rotor 28 suitable for placement underneath the water. Furthermore, a wave energy pump 30 is connected to the power plant 10.

The windmill 12 is illustrated in a schematic cut-through view illustrating that the rotor 18 is connected via a shaft 32 to a pump 34. The pump 34 generates the pressurised fluid received via the pipe system 36 and delivers fluid at an elevated pressure to the pipe system. The rotor 18, shaft 32 and pump 34 are placed in the mill tower 38 so that the rotor may be elevated with respect to the ground 40.

Also included in the tower 38 is a hydrophore or pressurised reservoir 42. The hydrophore or pressurised reservoir 42 may be used for compensation for the fluctuations in the pressurised fluid generated by the pump 34 in situations where the rotor 18 is influenced by changing or fluctuating winds causing the rotor 18 to rotate at non even speeds.

The pressurised fluid is delivered from the hydrophore 42 or alternatively directly from the pump 34 into a high pressure pipe system 44 receiving pressurised fluid from all of the pressure generating elements of the entire power plant 10, namely in FIG. 1 illustrated as the windmills 12,14,16, the sub water turbine 26 and the wave energy pump 30.

The pressurised fluid is delivered via the high pressure pipes 44 into a main hydrophore or pressurised reservoir 46 storing the pressurised fluid until it is to be delivered into an electrical power generator 48 constituted by a main turbine 50 connected via a shaft 52 to a generator 54, which is further connected to a transformer 56 transforming the electrical power generated by the generator 54 to a level suitable for delivering the electrical power into an electrical power supply grid. A control valve 58 may be used for a safety valve or flow regulation of the pressurised fluid delivered from the pressurised reservoir 46.

A feeding pump 60 may be used for ensuring that the fluid returns from the turbine 50 is returned into the feeding pipes 45 feeding the individual components of the power plant 10, in FIG. 1 namely the windmills 12, 14, 16, the sub water turbine 26 and the wave energy pump 30.

The embodiment illustrated in FIG. 1 is a closed system, where the fluid, preferably being water, is transported within a closed pipe system, however, an embodiment with one or more water intakes, e.g. placed at the individual windmills, sub water turbines or wave energy pumps may also be envisaged. The water may be filtered prior to entering the pipe system and may, after having driven the main turbine 50 be returned into the surrounding environment, preferably without being contaminated.

The friction laws or pressure laws in the pipe system may be reduced by adding a drag reducing additive for reducing the friction or viscosity of the water. Also an additive for ensuring that the water or fluid in the pipe system is not subject to frost, i.e. an additive lowering the freezing point of the fluid may be added to the fluid.

FIG. 2 is a schematic view of a hydraulic wind turbine,62 with piston displacement pumps 64. The main shaft 66 of the wind turbine or windmill 62 is connected to a crank-shaft 68 connected to three pistons 70, 72 and 74. The pistons 70, 72, 74 reciprocates in three cylinders 76, 78, 80 for pressurising the fluid received in the inlet 82. The pressurised fluid is delivered into the outlet 84 into a pipe 86 within the tower 88 of the windmill. The coupling between the pipe 86 and the outlet 84 is a rotation free sealing coupling allowing the head or top of the windmill or wind turbine to rotate depending on the direction of the wind so as to achieve maximum speed of the rotor 90. The pipe 86 both receives the pressurised fluid from the outlet 84 and also delivers fluid to the inlet 82.

The fluid is delivered to a local hydrophore 92 before it is conducted into a high pressure pipe system 94.

In the embodiment illustrated in FIG. 2, the main platform 96 includes a main hydrophore 98 receiving the pressurised fluid from the pipe system 94. The main hydrophore 98 may store the pressurised fluid until it is needed in the turbine for the generation of electrical power. The turbine 100 in this embodiment is a pelton-turbine connected to the electric generator 102. The remaining parts of the power plant 62 may be identical to or include parts of the embodiment illustrated in FIG. 1.

FIG. 3 is a view of the flow characteristics for a 3-cylindric hydraulic piston pump, i.e. as illustrated in FIG. 2. The y axes of the chart 104, 112, 120, 128 indicates the volume flow from each of the cylinders, where cylinder 1 is illustrated in chart 104, cylinder 2 is illustrated in chart 112 and cylinder 3 is illustrated in chart 120. As the rotor rotates and thereby drives the main shaft, each of the cylinders perform a specific displacement of volume illustrated by the curves 106-126.

The vertical dotted lines 130,132,134,136, 138,140 and 142 each represent a spacing of 60 degrees of rotation of the main shaft. As the three cylinders are connected to the same output, the resulting volume flow will be as illustrated in chart 128. As can be seen from chart 128, the fluctuations in the resulting volume flow will be minimal compared to the changes in volume flow from using only one piston. The fluctuations illustrated in chart 128 will be evened out by the use of the hydrophore in the tower.

FIG. 4 is a schematic cut-through view of a windmill or wind turbine 144 illustrating a gear box 146 connecting the main shaft 148 via a gear 150 to a high speed output shaft 152 for driving a multi-stage centrifugal pump 154. The gear 150 is a traditional windmill gear having a conical shape. The centrifugal pump 154 has an inlet 156 and an output 158 for receiving and delivering the fluid, respectively.

As discussed elsewhere in the present specification, the distribution of wind power due to variations in unsteady or unstable weather conditions may vary over an area where a wind turbine park is located. The variation in wind force and wind conditions such as wind direction may cause the wind turbines to rotate at different speeds. Even though various methods for adapting wing speed to wind speed, such as rotation of one or more of the wing blades in order to maintain a constant rotational speed of the windmill wings. Also, larger windmills or wind turbines may block or shade smaller, or other, windmills located near the large windmill.

One possible solution could be to couple the wind turbines directly to hydraulic pumps and each hydraulic pump being connected to a common pipe system delivering pressurised flow to a central hydropower station or via pressurised chambers as discussed elsewhere. The wind turbines and pumps may then be controlled to deliver flows at constant pressure and a central hydro turbo generator generating electrical power may be synchronised to a public electric power delivery grid.

FIGS. 5 and 6 schematically illustrate power and shaft moments as a function of mean rotor speed for typical 2 MW wind turbine. FIG. 5 shows characteristics of 2 MW windturbine at pitch angle θ and shaft power as function of mean wind- and rotor speed. FIG. 6 shows characteristics of 2 MW windturbine at pitch angle 0 and shaft power as function of mean wind- and rotor speed.

The solid lines indicate specific mean wind speeds. The normal operation of the wind turbine will follow the curve 160 being the optimal curve at low wind speed up to the design rotor speed marked by the line 162. When the wind speed, and thereby the rotor speed, reaches the design speed indicated by the line 162, the rotor maintains the constant speed but delivers a higher shaft power output indicated by the line 164 beginning at the point 166 ending at the maximum power 168.

The blade pitch angle is held constant along the curve 160 and the rotor speed is held constant along the curve 164 by increasing the pitch angle at higher wind loads. At extreme wind loads, the blades are pitched through to a neutral position. The dotted line 170 indicates the optimum power while the dotted line 172 indicates the maximum moment. The hydraulic wind turbine is able to operate with variable rotor speed in the region between the lines 160, 164 and 172.

FIG. 6 schematically illustrates a curve indicating the shaft moment as a function of the mean wind and rotor speed.

The shaft moment and the pump head of the piston pump are proportional, and FIG. 6 shows that wind turbines with a single piston pump are not able to operate at a constant level of pressure under unsteady weather conditions, indicated by comparison of the areas defined by the lines 190 and 192 for the shaft power as a function of mean wind and rotor speed, and the area defined by the lines 186 and 188 illustrating the shaft moment as a function of mean wind and rotor speed.

To operate at the same high pressure, it is necessary to install three different pumps having relative sizes of 1.2 and 4 and combine the operation of the three pumps, viz. pump 1, pump 2, pump 1+2, pump 3, pump 3+1, pump 3+2, and pump 3+2+1 to cover the whole allowed load region. This solution is contemplated to be complicated and will require several valves to control the flow. To reduce pressure and flow discontinuities under pump shift it is necessary to install buffers in the pipe system.

One possible way to overcome the above-mentioned problems is to implement a single system pump according to the present invention designed to operate at constant high pressure in the whole allowed load region for wind turbines.

A pressure pump is schematically illustrated in FIG. 7 where a lever arm 190 being connected in one end to a crankshaft at 192 via a connecting rod 194 and a crank 196 and 198. The crank 198 is connected to a piston pump similar to that illustrated in FIG. 7 in order for the system to include four pistons or cylinders.

The crankshaft rotates in the direction of the arrow 200 driving the cranks 196 and 198. The crank 196 exerts a force via the rod 194 to one end of the arm 190.

The arm 190 is connected to a piston rod 207 via a piston rod bearing at a cross head 205. As the arm 190 is rotated or pivoted at the point 202, the end of the arm 190 being connected at 205 moved the piston rod 207 in the direction of the arrow 212 thereby moving the piston heads 215 and 216.

The arm 190 has a centre of rotation or pivot point at 202 as the arm 190 is received in a spherical bearing 204 allowing the arm 190 to rotate or pivot. The spherical bearing 204 is mounted in a slider 206 so that the centre of rotation or pivot point 202 may be moved, shifted or repositioned, thereby changing the force exerted by the arm 190 on the piston rod 207 so that variations in the force exerted by the arm 202 may be adapted to result in a constant pressure delivered from the cylinders 208 and 210.

As the crankshaft 292 is driven by the rotor of a windmill, alternatively a water mill, e.g. placed under water, not illustrated, and variations in the speed of the rotor may occur, a need exists to allow for compensation of the speed at which the pistons 216 and 215 are moved and thereby control the pressure of the fluid delivered form the containers 208 and 210. The system relies on the principle of the lever. The slider 206 is supported by bearings 214 and 217 allowing the slider 206 to slide in the direction of the arrow 218.

FIG. 7a schematically illustrates the volume flow as a function of the angle or phase where the curve 220 illustrates a two cylinder pump, 220a and 220b and the curve 222 illustrates a four cylinder pump, illustrating that the volume flow in a system having four cylinders, 222a, 222b, 222c and 222d, is more even than the volume flow of a system having only two cylinder pumps.

FIG. 8 schematically illustrates an embodiment of the piston pump of FIG. 7. The piston pump 224 includes an arm 226 where the arm is held by a slider 228 being pivotally connected to a supporting rocker arm 230. A cut-through view of the arm 226 being received within the slider 228 is illustrated in FIG. 8a. The slider 228 includes i slider bearing 232 being held by the supporting rocker arm 230. The line 234 indicates a line of symmetry.

The supporting rocker arm 230 is actuated by a control rod 236 so as to regulate or control pressure delivered by the piston pump.

The arm 226 is connected in one end, viz. at 238, to a connecting rod 240 connecting the arm 226 to a crankshaft 242. As the crankshaft 242 rotates in the direction of the arrow 244, the connecting rod 240 exerts a force on the arm 226 at 238 causing the arm to rotate around a centre of rotation or pivot 246. The end opposite 238, viz. 246, the arm 226 is connected to a piston rod 248 at either end of the piston rod 248, piston heads 250 and 252 is located. The piston heads 250 and 252 moving in the direction of the arrow 254 for delivery of pressurised fluid via the chambers 256 and 258 to pipe systems not illustrated here. The cylinders or chambers 256 and 258 also include valves for regulating the flow of fluid in and out of the chambers of cylinders 256 and 258. The valves are denoted 260.

The pump system 224 transforms rotational energy via the crankshaft 242 through the connecting rod 240 transforming the rotational motion of the crankshaft 242 into a pendulum motion of the arm 226. The arm 226 rotates around the centre of rotation 246 transforming the pendulum motion of the arm into a reciprocating motion of the piston rod 248 and thereby also of the piston heads 250 and 252.

The control rod 236 is reciprocated in a controlled manner in order to control and vary the rotation or pivoting of the arm 226 by shifting or relocating the centre of rotation or pivot 246. The rocker arm 230 is fastened to a supporting base 264 and has a centre of rotation or pivot 266 in a support bearing. The control rod 236 may be controlled via a screw actuator 268 and may include a piston 270 received in a cylinder 272, alternatively being a hydraulic actuator.

The pump 224 illustrated in FIG. 8 may also include a second crankshaft 274 connecting to a second arm similar to that illustrated in FIG. 8.

FIG. 8a is a schematic view along the line 262 in FIG. 8.

From FIG. 8a it is also seen that the supporting rocker arm 230 supports a slider bearing 232 of the slider 228. The line 234 indicates a line of symmetry along the cut. The arm 226 is received within the slider 228.

The present invention may be characterised by the following points:

1. Power plant for the generation of electrical power using wind power or wind energy, comprising:
a plurality of windmills each comprising a mill tower, a rotor with a shaft being rotatably journalled in the mill tower, a fluid pressure generator mounted in the mill tower and being coupled to and driven by the shaft for delivering pressurised fluid via a pressure channel,
a pressure accumulating reservoir communicating with the pressure channels for receiving the pressurised fluid therefrom, and
a pressure driven electrical power generator connected to the pressure accumulating reservoir and being driven by the pressurised fluid for generation of electrical power, the electrical power delivered to an electrical power supply grid.
   2. The power plant according to point 1, wherein the pressurised fluid is constituted by a liquid, such as seawater or freshwater including friction reducing additive or a gas, such as an inert gas, such as nitrogen or atmospheric air.
   3. The power plant according to any of the points 1 or 2, wherein the pressurised fluid is in a closed system including a return pump for returning the pressurised fluid from the pressure driven electrical power generator or a open system wherein the pressurised fluid is delivered to the surroundings from the pressure driven electrical power generator.
   4. The power plant according to any of the points 1-3, wherein each of the shafts of the windmills is a horizontal or vertical shaft.
   5. The power plant according to any of the points 1-4, wherein the fluid pressure generator is a slow-moving displacement pump, preferably a membrane-piston pump.
   6. The power plant according to any of the points 1-5, wherein the fluid pressure generator is coupled to the shaft via a gear means having a conical output stage, so that the output shaft co-insides with the shaft through the nacelle of the windmill, and being a multi-step centrifugal pump or screw pump or Archimedean screw.
   7. The power plant according to any of the points 1-6, wherein the fluid pressure generator includes a valve, the valve in a closed state functioning as a break for the windmill.
   8. The power plant according to any of the points 1-7, wherein the pressure accumulating reservoir is placed in or on a central platform with the pressure driven electrical power generator.
   9. The power plant according to any of the points 1-8, further including a multitude of pressure reservoirs positioned at one or more windmills.
   10. The power plant according to any of the points 1-9, wherein the pressure reservoir is constituted by at least two pressure reservoirs in a series or parallel connection.
   11. The power plant according to any of the points 9 or 10, wherein each of the multitude of pressure reservoirs is integral with the windmill and in the form of a hydrophore in the body of the mill tower or the foundation of the windmill.
   12. The power plant according to any of the points 1-11, wherein pressure driven electrical generator is controlled with regulated number of revolutions for sustaining synchronism with the electrical grid.
   13. The power plant according to any of the points 1-12, wherein the pressure accumulating reservoir is further connected to at least one fluid pressure generator being coupled to wave power plants or water turbine plants.
   14. A windmill for use in a power plant according to any of the points 1-13, wherein the windmill includes a mill tower, a rotor with a shaft being rotatably journalled in the mill tower, a fluid pressure generator mounted in the mill tower and being coupled to and driven by the shaft for delivering pressurised fluid via a pressure channel.
   15. The windmill according to point 14, wherein the windmill further includes any of the features of any of the points 1 and/or 2-3.
   16. A method of producing electrical power from wind energy, comprising:
i) providing at least one windmill including a mill tower, a rotor with a shaft being rotatably journalled in the mill tower, a fluid pressure generator mounted in the mill tower and being coupled to and driven by the shaft for delivering pressurised fluid via a pressure channel, the wind energy driving the rotor,
ii) providing an electrical power generator communicating with the pressure channel,
iii) driving the electrical power generator with the pressurised fluid for the generation of electrical power,
iv) delivering the electrical power to an electrical power supply grid or an electrical power storage.
   17. The method according to point 16, further comprising intermediate steps after step ii):
a) providing a storage device for storing the pressurised fluid under pressure, the storage device in communication with the pressure channels and the electrical power generator, and
b) delivering the pressurised fluid to the electrical power generator.
   18. The method according to point 17, further comprising a step of providing a monitoring means for monitoring demand for electrical power on the electrical power supply grid,
performing the step b) when the monitoring means detect a specific need in the electrical power supply grid.
   19. The method according to any of the points 16-18, wherein the at least one windmill includes any of the features of any of the points 1 and/or 2-13.

1-26. (canceled)

27. A pressure generating pump comprising:
a pressure pump housing in which a pressure chamber is defined, said chamber having a fluid inlet configured to receive a non-pressurized pressure fluid, and a fluid outlet configured to supply a pressurized pressure fluid;
a piston rod having a piston head received within said pressure chamber for creating reciprocal movement within said chamber;
a rotatably journalled power-transmitting axle receiving rotational motion from a rotational motion generator;
a crankshaft assembly connected to said axle so as to transform said rotational motion into a pendulum motion; and
a power regulating and transmitting lever arm assembly defining a first end and a second end, said first end being connected to said crankshaft assembly and said second end being connected to said piston rod to transform said pendulum motion into said reciprocating movement;
said lever arm assembly being journalled on a repositionable pivot that is repositionable between said first and second ends, and said lever arm assembly defining a first arm between said first end and said pivot and a second arm between said pivot and said second end, the lengths of said first and second arms being changed by the repositioning of said pivot.

28. The pressure generating pump according to claim 27, wherein said pressure generating pump includes a plurality of pressure chambers.

29. The pressure generating pump according to claim 28, wherein said pressure chambers are provided in pairs operating in a push-pull configuration.

30. The pressure generating pump according to claim 27, wherein said repositionable pivot is fixed to a base at one end.

31. The pressure generating pump according to claim 27, wherein the ratio between the lengths of said first arm and said second arm is variable in the interval 1:1 to 1:1000.

32. The pressure generating pump according to claim 27, wherein said pressure chamber includes a sealing member and comprises first second pressure chambers on the distal and proximal side, respectively, of a piston head.

33. A power plant for the generation of electrical power using wind power or wind energy, comprising:
a plurality of windmills each comprising a mill tower, a rotor with a shaft rotatably journalled in said mill tower, a fluid pressure generator mounted in said mill tower and coupled to and driven by said shaft to deliver a pressurized fluid via a pressure channel, a pressure reservoir positioned within said mill tower and in fluid communication with said fluid pressure generator and said pressure channel;
a pressure accumulating reservoir communicating with said pressure channel so as to receive said pressurized fluid therefrom; and
a pressure-driven electrical power generator connected to said pressure accumulating reservoir and driven by said pressurized fluid so as to generate electrical power for delivery to an electrical power supply grid.

34. The power plant according to claim 33, wherein said pressurized fluid comprises a liquid and a friction-reducing gas.

35. The power plant according to claim 33, wherein said pressurized fluid is in a closed system including a return pump operable to return said pressurized fluid from said pressure-driven electrical power generator.

36. The power plant according to claim 33, wherein said pressurized fluid is in an open system wherein said pressurized fluid is delivered to a surrounding environment from said pressure driven electrical power generator.

37. The power plant according to claim 33, wherein said fluid pressure generator is a slow-moving displacement pump.

38. The power plant according to claim 33, wherein said fluid pressure generator is coupled to said shaft via a gear mechanism having a conical output stage, so that said output shaft coincides with said shaft through a nacelle of said windmill.

39. The power plant according to claim 38, wherein said pressure generator is selected from the group consisting of a multi-step centrifugal pump, a screw pump, and an Archimedean screw.

40. The power plant according to claim 33, wherein said fluid pressure generator includes a valve that functions in a closed state as a break for said windmill.

41. The power plant according to claim 33, wherein said pressure accumulating reservoir is placed in or on a central platform with said pressure driven electrical power generator.

42. The power plant according to claim 33, further comprising a multitude of pressure reservoirs positioned at one or more windmills.

43. The power plant according to claim 33, wherein said pressure reservoir is a first pressure reservoir, said power plant further comprising at least one second pressure reservoir

44. The power plant according to claim 43, wherein the first and the at least one second pressure reservoirs are in a series connection.

45. The power plant according to claim 43, wherein the first and the at least one second pressure reservoirs are in a parallel connection.

46. The power plant according to claim 42, wherein each of said multitude of pressure reservoirs is integral with said windmill and is configured as a hydrophore in said windmill.

47. The power plant according to claim 33, wherein the pressure driven electrical generator is controlled with a regulated number of revolutions for sustaining synchronism with said electrical grid.

48. The power plant according to claim 33, wherein said pressure accumulating reservoir is further connected to at least one fluid pressure generator coupled to a power plant selected from the group consisting of a wave power plants and a water turbine plant.

49. The power plant according to claim 33, wherein at least one of said windmills includes a pressure generating pump according to any of the claims 27-32.

50. A windmill, comprising:
a mill tower;
a rotor with a shaft rotatably journalled in said mill tower;
a fluid pressure generator mounted in said mill tower and coupled to and driven by said shaft so as to deliver a pressurized fluid via a pressure channel; and
a pressure reservoir positioned within said mill tower and in fluid communication with said fluid pressure generator and said pressure channel.

51. The windmill according to claim 50, wherein said fluid pressure generator includes a pressure generating pump in accordance with any of the claims 27-32.

52. A method of producing electrical power from wind energy, comprising:
i) providing a windmill including a mill tower, a wind-driven rotor with a shaft rotatably journalled in said mill tower, a fluid pressure generator mounted in said mill tower and coupled to and driven by said shaft to deliver a pressurized fluid via a pressure channel, a pressure reservoir provided within said mill tower and in fluid communication with said fluid pressure generator and said pressure channel;
ii) providing an electrical power generator communicating with said pressure channel;
iii) driving said electrical power generator with said pressurized fluid for the generation of electrical power;
iv) delivering said electrical power to an electrical power supply grid or an electrical power storage.

53. The method according to claim 52, further comprising, after step ii):
a) providing a storage device to store said pressurized fluid under pressure, said storage device being in communication with said pressure channel and said electrical power generator; and
b) delivering said pressurized fluid to said electrical power generator.

54. The method according to claim 53, further comprising:
providing monitoring means to monitor demand for electrical power on said electrical power supply grid; and
performing said step b) when said monitoring means detect a specific need in said electrical power supply grid.
